(19) United States
(12) Patent Application Publication
(10) Pub. No.: US 2014/0159751 A1
(43) Pub. Date: Jun. 12, 2014

(54) Passive Multi-Layered Corrosion Sensor

(71) Applicants: Lloyd Hihara, Mililani, HI (US); Alicia Higa-Brauneck, Hawthorne, CA (US); George Hawthorn, Kaneohe, HI (US)

(72) Inventors: Lloyd Hihara, Mililani, HI (US); Alicia Higa-Brauneck, Hawthorne, CA (US); George Hawthorn, Kaneohe, HI (US)

(21) Appl. No.: 13/970,714

(22) Filed: Aug. 20, 2013

Related U.S. Application Data
(60) Provisional application No. 61/691,243, filed on Aug. 20, 2012.

(51) Int. Cl. G01N 17/04; G01N 27/12

(52) U.S. Cl. CPC G01N 17/04; G01N 27/12
USPC 324/700

(57) ABSTRACT

The invention concerns corrosion sensors comprising a resistor, a voltage meter for determining voltage output across said resistor; and at least three different layers, each layer comprising a different material, said layers comprising: (a) non-corrosive conducting layer; (b) metal layer; and (c) electrically insulating layer deposed between the conducting layer and the metal layer; wherein the resistor connects the conducting layer and the metal layer. The invention further concerns use of such sensors use in monitoring and trouble-shooting corrosion impacts.

### CROSS REFERENCE TO RELATED APPLICATIONS

This application claims benefit of U.S. Patent Application Ser. No. 61/691,243, filed Aug. 20, 2012, which is incorporated by reference in its entirety herein for all purposes.

### GOVERNMENT RIGHTS

The subject matter disclosed herein was made with government support under contract WI5QKN-07-C-0002 awarded by the U.S. Army. The Government has certain rights in the herein disclosed subject matter

### TECHNICAL FIELD

The invention concerns corrosion sensors and their use in monitoring and trouble-shooting corrosion impacts.

### BACKGROUND

U.S. Pat. No. 5,286,357 discloses a corrosion sensor for detecting surface corrosion by a sensor constructed from a thin flexible non-conducting substrate that is attached to the monitored surface and an array of at least two thin flexible metallic electrodes disposed closely adjacent to one another so as to allow generation of electric current by electrochemical action there between as the electrodes corrode.

U.S. Pat. Nos. 5,310,470 and 5,338,432 disclose a plurality of corrosivity sensors designed to be embed between the layers of a composite structure or placed on a surface beneath a coating. The sensors comprise a thin non-conductive base and two electrically isolated conductive elements fixed to the surface of the base. Each conductive element has a bus bar and a plurality of strips extending from the bus bar and interdigitated with the strips of the other conductive element.

U.S. Pat. Nos. 6,683,463 and 6,987,396 concern an array of metallic electrodes arranged within a base such that each electrode has a small area exposed on one surface of the base. In the array, each electrode is electrically insulated from other electrodes within the base and a common electrical lead connects each electrode to the voltmeter.

There is need in the art for simple, inexpensive, small and long lasting corrosion sensors.

### SUMMARY

In some aspects, the invention concerns corrosion sensors comprising: a resistor, a voltage meter or voltage data logger for determining voltage output across the resistor; and at least three different layers, each layer comprising a different material, the layers comprising: (a) corrosion-resistant conducting layer; (b) metal layer; and (c) electrically insulating layer deposed between the conducting layer and the metal layer; wherein the resistor connects the conducting layer and the metal layer.

In some sensors, the conductive layer comprises at least one of graphite, gold and platinum. In certain sensors, the conductive layer comprises carbon/epoxy or graphite/epoxy fiber composite. In some sensors, the insulating layer comprises an insulating polymer or ceramic. Some insulating layers comprise E-glass.

In certain embodiments, the metal layer comprises a passive metal. In some preferred embodiments, the passive metal comprises aluminum.

The corrosion sensors of the invention may additionally comprise a voltage data logger for recording the voltage or current across the resistor. Certain sensors do not have a power source other than that for the data logger.

In yet other embodiments, the invention concerns methods for monitoring corrosivity of an environment in real time comprising:

placing a corrosion sensor described herein into the environment to be monitored;

monitoring the voltage across the resistor; and

correlating the voltage with corrosivity.

In certain embodiments, the voltage with corrosivity is made utilizing a set of calibration data, the set of calibration data relating voltage to corrosivity. In certain embodiments, the monitoring is accomplished by monitoring galvanic action between the conducting layer and the metal layer.

In yet other embodiments, the invention concerns methods of recording the corrosivity history of an environment, the method comprising:

placing a corrosion sensor described herein into the environment to be monitored;

monitoring the voltage across the resistor; and

correlating the voltage with corrosivity.

In some embodiments, the corrosion sensor has a carbon or graphite fiber fabric on top of an insulating layer of glass fiber fabric that is consolidated together with an epoxy matrix. This process renders the carbon and glass layers virtually inseparable, adding to its durability. This dual-layer with the glass fabric on the bottom is then bonded on top of the metal layer that may be selected to be pure aluminum. During the operation of the sensor, the aluminum layer that serves as the anode inevitably corrodes which results in the formation of some aluminum oxide product that has been found to not affect the performance of sensor. In addition, the carbon or graphite layer that serves as the cathode also does not generate any products that have been found to affect the performance of the sensor. This combination of materials makes this corrosion sensor unique and extremely durable. Many of these sensors have been in the field for approximately five years and are still producing data.

The dual carbon-glass layer is approximately ½ mm thick, with each layer approximately ¼ mm thick. Layers can vary in thickness according to needs. For example, each layer may be 1/16 to 1 mm thick. In some embodiments, each layer may be ⅛ to ½ mm thick. The pure aluminum layer is also approximately ½ mm thick in some embodiments. The thickness of this layer may also vary according to needs. In certain embodiments, the thickness of the aluminum layer may be ⅛ to 1 mm thick. The resulting corrosion sensor has a thickness of approximately 1 mm in some embodiments. As noted above, this total thickness can vary. In some embodiments, the total thickness can be ⅜ mm to 10 mm thick.

Other corrosion sensors that use thin films of metal (e.g., electroplated or evaporated) for electrodes can lack durability and longevity as the electrodes are rapidly consumed. In this sensor, the pure aluminum has inherently high corrosion resistance, but corrodes more rapidly when it is galvanically coupled to carbon in the presence of chlorides. Hence, this corrosion sensor is sensitive to the chloride concentration in the environment. Using an aluminum alloy rather than pure aluminum may result in the alloying elements (e.g., copper) fouling the sensor.

### BRIEF DESCRIPTION OF THE DRAWINGS

FIG. 1 presents an example of a postage-stamp sized PML corrosion sensor.

FIG. 2 shows that the output of PML sensors is sensitive to wetness.

FIG. 3 shows that output of the sensors can be correlated to chloride concentration.

FIG. 4 shows that data collected in the field shows distinct variation in sensor output based on environmental conditions. Note that the higher signals indicate higher chloride levels at a marine site in comparison to lower signals at non-marine sites with low chloride levels.

FIGS. 5-7 shows results for sensitivity to chloride test using solutions with varying amounts of Cl.

FIGS. 8-10 shows the effect of data sampling rate.

FIG. 11 shows the effect of sampling interval on corrosivity index (CI).

FIGS. 12-15 show CS output in CCTC using GM9540P Accelerated Corrosion Test.

FIG. 16 shows CI for various 12-cycle periods in the CCTC.

FIG. 17 presents a plot of CI versus cycles in the CCTC using GM9540P.

FIG. 18 shows voltage results over time for composite tests (Waipahu, Ewa Nui, and Campbell Industrial Park)

FIG. 19 presents additional composite field performance results (Coconut Island, Kahuku, and Lyon Arboretum).

FIGS. 20 and 21 present 1 year exposure data at Kahuku and Laie.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. When any variable occurs more than one time in any constituent or in any formula, its definition in each occurrence is independent of its definition at every other occurrence. Combinations of substituents and/or variables are permissible only if such combinations result in stable compounds.

A passive multi-layered corrosion sensor (PML, also referred to as CS) was developed that measures corrosivity of the environment. The corrosion sensor is sensitive to corrosives such as chlorides, and can estimate its levels in the environment. The sensor data produces signals from which information such as time of wetness and wetting and drying cycles can be determined. The data can also be processed to determine the total amount of corrosion accumulated within the sensor. The sensor is “passive” and does not require any power source. An off-the-shelf data logger can be used to capture the sensor output. Such data loggers can be portable, small in size, and powered by a small battery. The sensor is robust and can be operated for multiple years in the field.

The PML sensor is fabricated from at least three different layers of materials. Its size can be tailored for needs of the application. Prototype PML sensors were fabricated with sizes typical of a postage stamp. The sensors can be constructed as a flat structure that can be attached to a substrate with an adhesive. CS can be fabricated using various material systems for probing the corrosivity of different corrosives. The sensor can contain materials that are conductors, insulators, and or semi-conductors. The layers that make up the sensor can be constructed by conventional techniques.

The PML sensor is fabricated with at least three layers of material. One layer is a noble conductor (also referred to as “non-corrosive conductor”), the intermediate layer is an electrical insulator, and the third layer is a metal. The noble conducting layer is preferably made of an inert material that will not itself corrode and contaminate the sensor. Some inert conducting materials are graphite, titanium, gold and platinum. Carbon-fiber-reinforced polymers (composite materials) can be utilized. Certain preferred materials include carbon/epoxy and graphite/epoxy fiber composites.

The electrically insulating layer can be made of any insulating material such as a polymer, glass, insulating ceramic, or composite. In some embodiments, insulators can be from electrically-insulating, engineering ceramics such as alumina or silicon nitride, or a polymer-matrix composite that is reinforced with electrically-insulating fibers such as glass, alumina, or aramid (such as Kevlar®, a para-aramid marketed by DuPont). In certain embodiments, composites comprising one or more electrically-insulating fibers (glass or alumina, for example) in a polymer matrix of plastic, silicone rubber or ethylene propylene diene monomer rubber (EPDM) may be used. One preferred insulating layer was made from an E-glass/epoxy composite.

The metal layer can be either an active metal or passive metal. For sensitivity to corrosives such as chlorides, the passive metal should have corrosion pitting potentials that are a function of chloride concentration. One ideal passive metal for this sensor is aluminum. Various aluminum alloys and aluminum of various purity levels can be used. In some embodiments, ideally, high purity aluminum (i.e., more than 99.9% Al) should be used. This will ensure that the aluminum sensor will not unnecessarily corrode. Another advantage of aluminum is that its corrosion products will not plate out on the noble conductor and foul the sensor.

The metal layer can also be coated to obtain information on the protective nature of a particular coating. Hence, a modified PML sensor made of a coated metal can be used to study the deterioration of the coating. The metal layer can undergo the normal preparation and coating procedure prior to bonding to the insulative layer. This approach allows the coating system of interest to be studied in its intended state.

The PML sensor works by galvanic action between the noble layer and the metal layer. The voltage output is obtained from the sensor by connecting noble layer and metal layer through a resistor, A voltage is generated through the resistor by the flow of galvanic current. The resistor is selected so that the voltage output is in the millivolt range so as not to impede the galvanic current.

As used herein, the term “voltage meter” includes any instrument suitable to measure the voltage across the resistor. The term “resistor” is commonly known in the art—an electrical component designed to introduce a known value of resistance into a circuit. The resistance of the resistor is selected to provide an appropriate voltage for reading by the voltage meter. Determination of such values is within the ability of those skilled in the art.

The term “layer” means a thickness of some material laid over a surface. In the present invention, at least 3 layers are stacked such that each layer is in contact with at least one other layer.

The PML sensor can characterize the environment in which it is exposed, and hence, it can be used for multiple purposes, Some non-limiting example applications are:

1) The PML sensor can indicated if corrosion is occurring in hard to reach and hidden locations; such as, under the floor boards of helicopters, under the carriage of trucks and automobiles, and behind double-walled structures. The sensor can alert when corrosion is likely to occur in the hidden locations, eliminating unnecessary inspections, and conducting maintenance only when required. Information from corrosion sensors can be used to alert users when to clean or reapply corrosion preventive compounds or to develop maintenance schedules and procedures;

2) The PML sensor can be used to record the corrosivity history of the environment in which a particular asset was exposed. The PML sensor can be used to determine if assets have been thoroughly cleaned after being exposed to corrosive environments. For example, the PML sensors can indicate if vehicles have been washed down after use in marine environments or after exposure to de-icing salts; and

3) The PML sensor can be used to trouble shoot the cause of corrosion when it is caused by environmental conditions. It can be used to determine if corrosion occurs continuously or periodically, which could link it to other environmental factors (e.g., condensation).

The PML sensor is durable, relatively small, and has a flat profile making it easy to mount. Multiple types of parameters can be extracted from the sensor by data processing. Corrosives such as chloride concentration, time of wetness, and wetting and drying cycles can be extracted from the single sensor. Other systems require multiple sensors to obtain similar information. Other sensors on the market can be bulky and cannot be easily mounted to flat surfaces. Other sensors provide limited information and only indicate that corrosion is occurring. The PML sensor is passive and does not require a power source, other than the data logger to record its signals. The PML sensor is durable and can be used for multiple years. The PML sensor can eliminate the need for multiple sensors and a large mounting profile.

The PLM sensor is “passive” and does not require any power source. An off-the-shelf data logger can be used to capture the sensor output. Such data loggers can be portable, small in size, and powered by a small battery. The sensor is robust and can be operated for multiple years in the field. The PML sensors can be used for many purposes such as 1) to monitor the corrosion activity in aircraft, especially in difficult to access locations such under floor boards, 2) to monitor the history of corrosion activity of a particular asset (e.g., aircraft, helicopter, truck, etc.), and 3) alert users when to clean or inspect an asset.

As required, detailed embodiments of the present invention are disclosed herein; it is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the invention to be better understood. However, they are given merely by way of guidance and do not imply any limitation.

### EXAMPLES

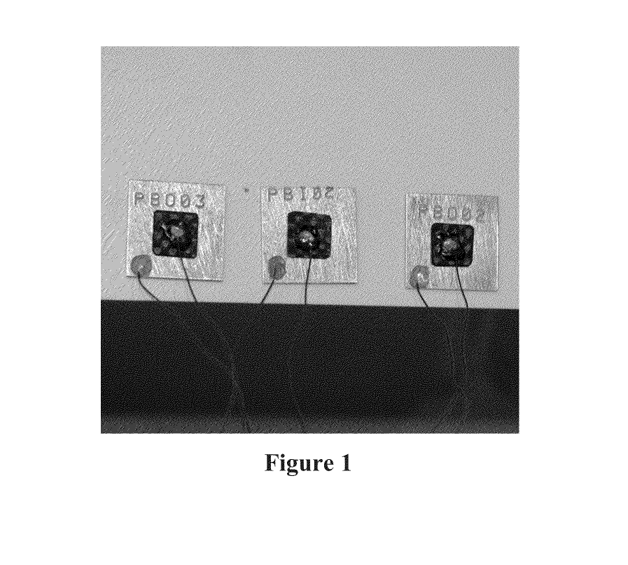

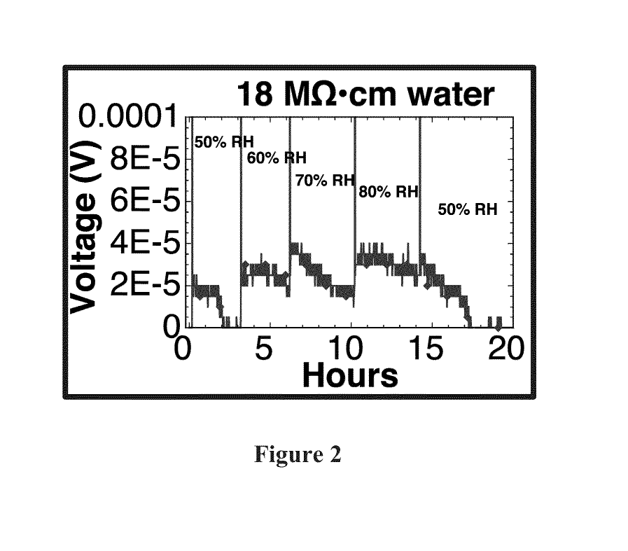

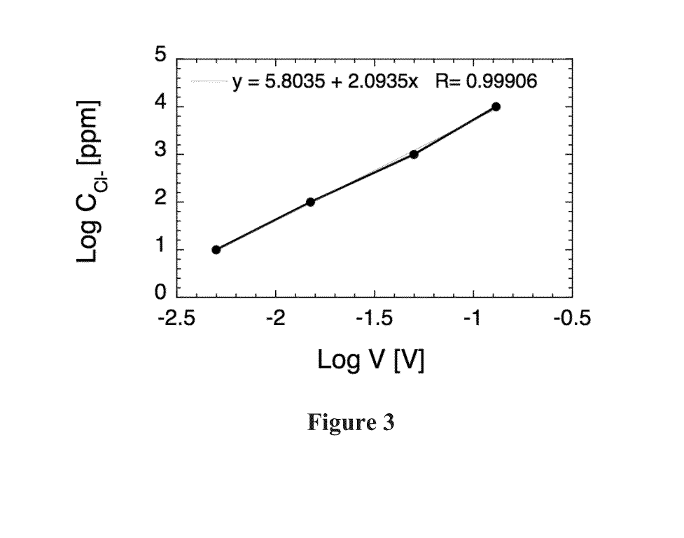

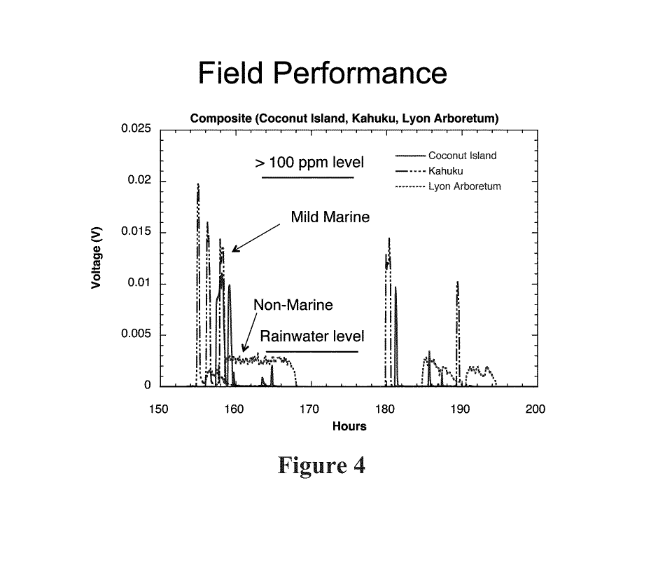

An example of a postage-stamp sized PML corrosion sensor is shown in FIG. 1. Sensors of any suitable size can be made depending on the environment to be monitored. The output of such sensors is sensitive to wetness (FIG. 2) and chloride concentration (FIG. 3). Data collected in the field shows distinct variation in sensor output based on environmental conditions. Notice higher signals indicating higher chloride levels at one marine site in comparison to non-marine sites with low chloride levels (FIG. 4).

The PML sensors are used to monitor the corrosion activity in aircraft. A sensor is placed under the floor board of a helicopter to monitor corrosion. Sensors can be used in other difficult to access locations as well. In addition to helicopters, PML sensors can be used to monitor corrosion in aircraft, trucks, cars and other vehicles. The sensors can be used in industrial, business or residential settings as needs dictate. In addition to monitoring corrosive environment history, the sensor output can be used alert users when to clean or inspect an asset.

The response of prototype corrosion sensors (CSs) to electrolytes of varying chloride concentrations was studied in the cyclic corrosion test chamber (CCTC). The electrolytes ranged from chloride concentrations varying from less than 1 ppm to 10,000 ppm (on the order of seawater concentration). The CS was tested in the CCTC using the GM9540P

Accelerated Corrosion Test. The CS were also fielded.

For data acquisition, the CSs were hooked up to data loggers. The data loggers were encased in moisture-tight polycarbonate boxes. Tests were performed in a Cyclic Corrosion Test Chamber. The CSs were mounted at 45° to horizontal in the CCTC. The wetting and drying cycle used was as follows:

Spray (10 sec), 50% RH (3 hrs)

Spray (10 sec), 60% RH (3 hrs)

Spray (10 sec) 70% RH (4 hrs)

Spray (10 sec), 80% RH (4 hrs)

Spray (10 sec), 50% RH (10 hrs)

The CSs were exposed in the CCTC.

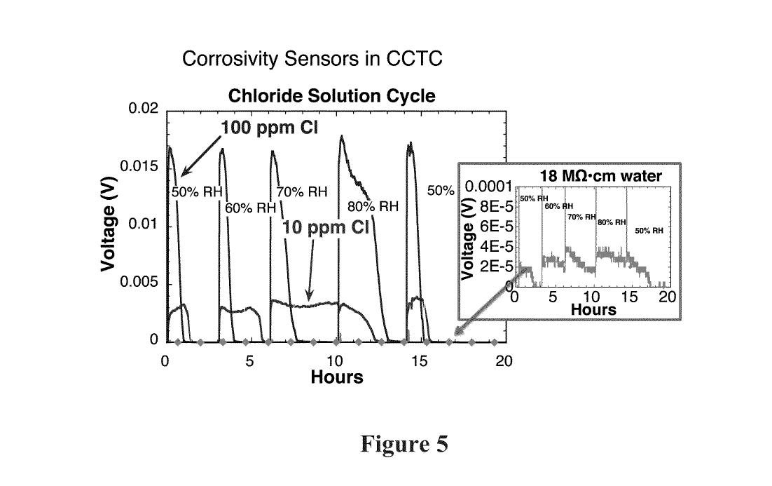

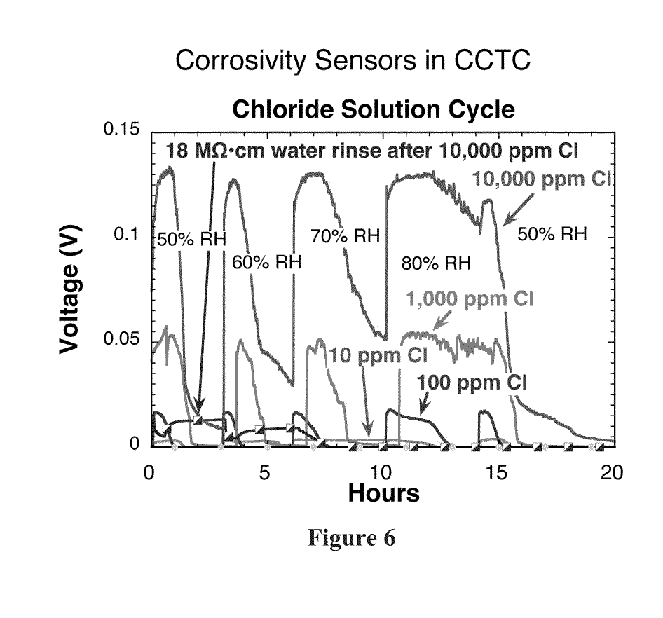

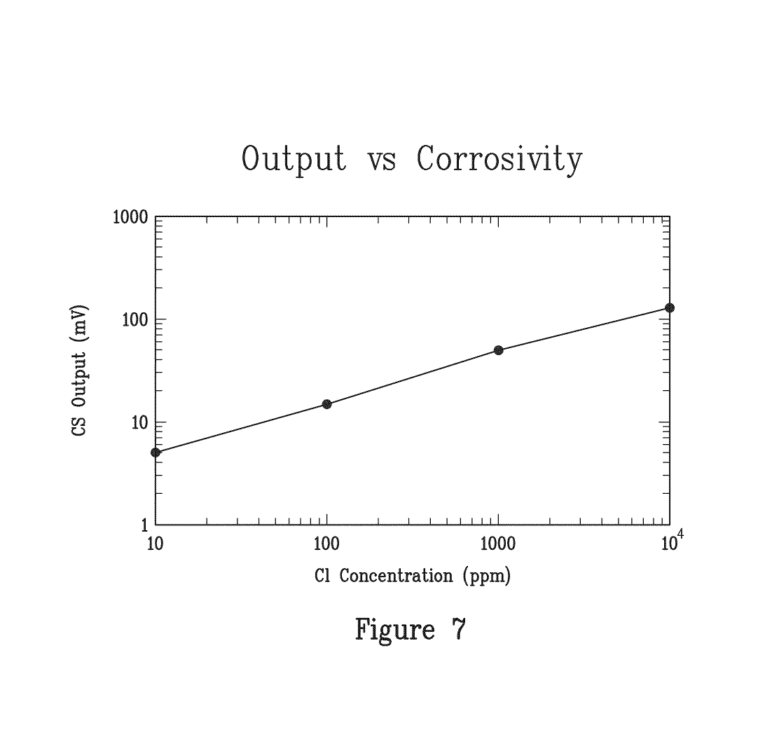

Results for CCTC chloride exposure are shown in FIGS. 5-7.

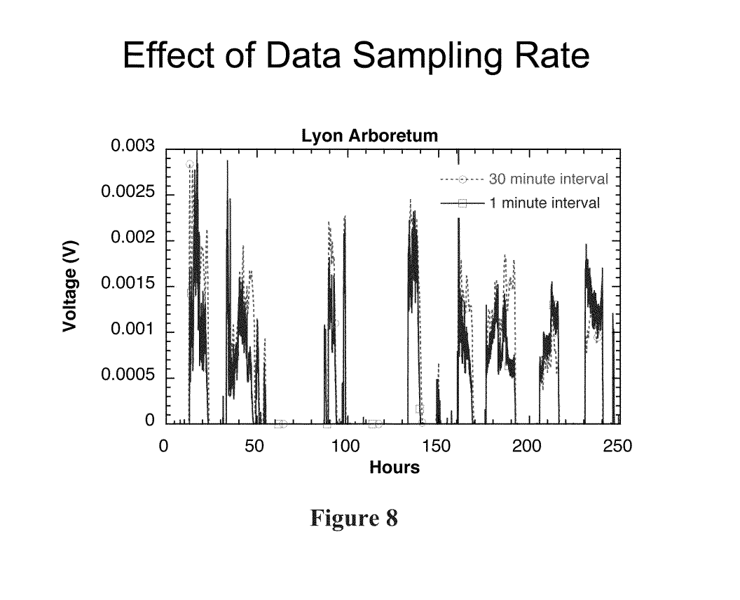

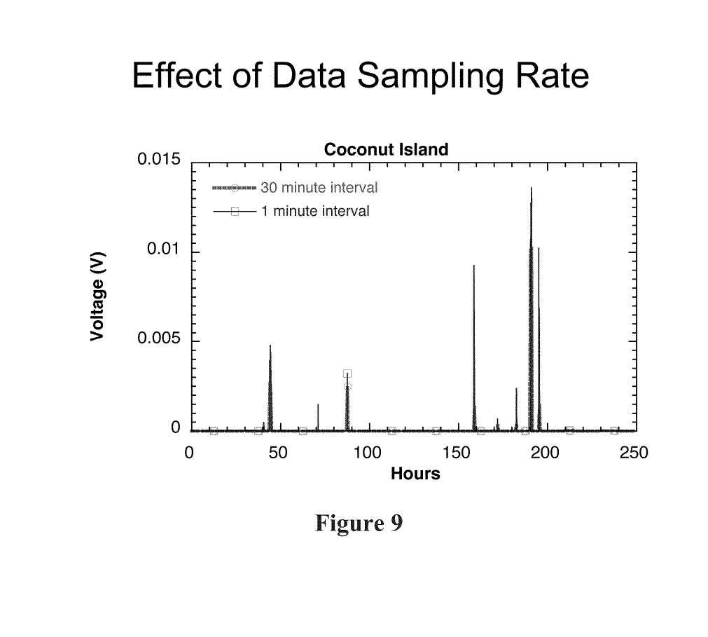

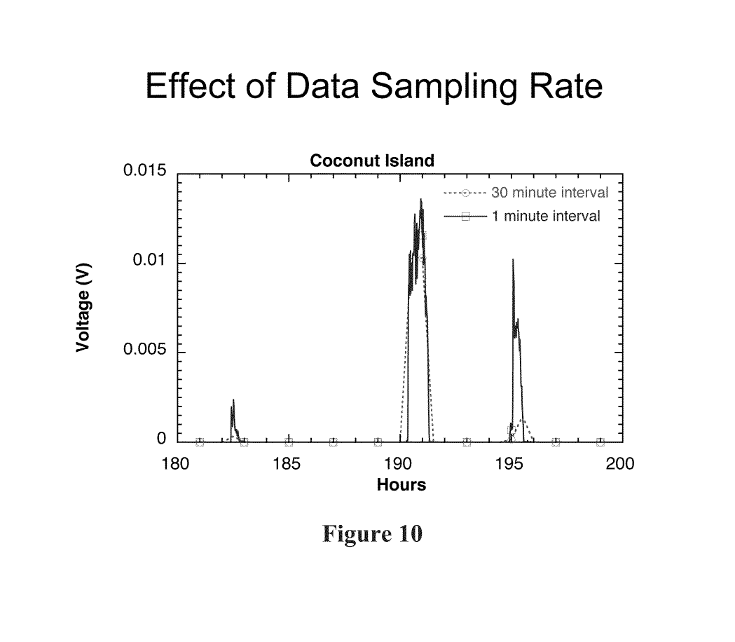

The effect of data sampling rate was also tested. Results are shown in FIGS. 8-10.

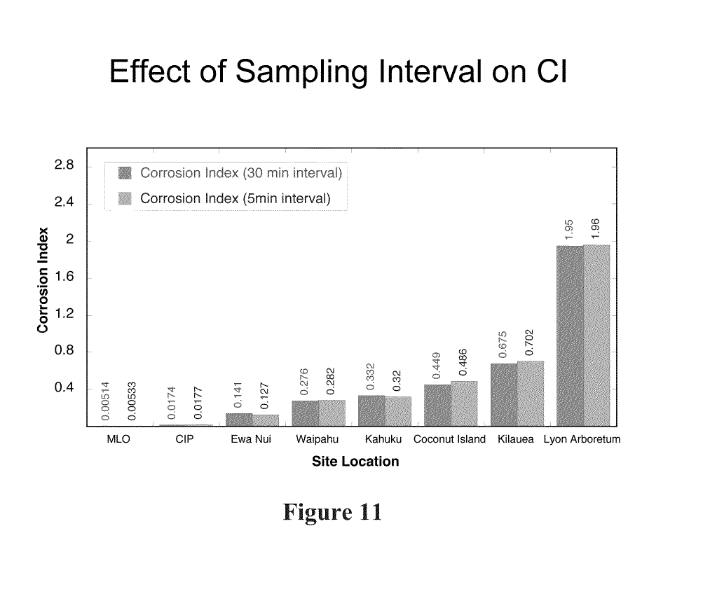

The corrosivity index (CI) is derived from the sensor data. FIG. 11 shows the effect of sampling interval on CI.

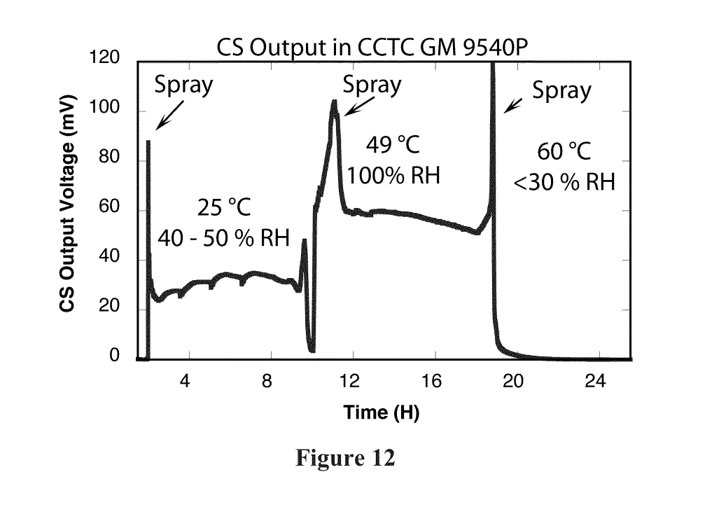

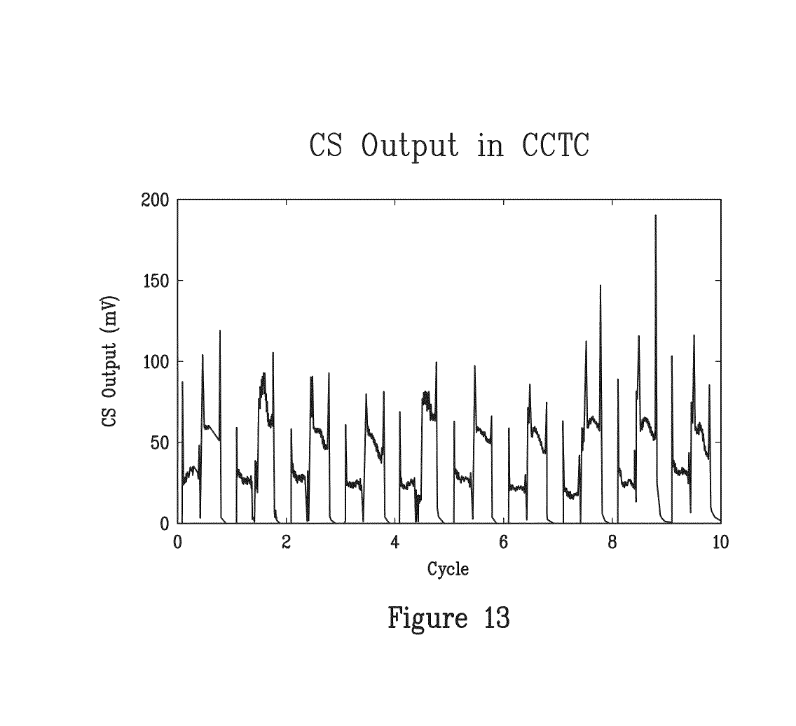

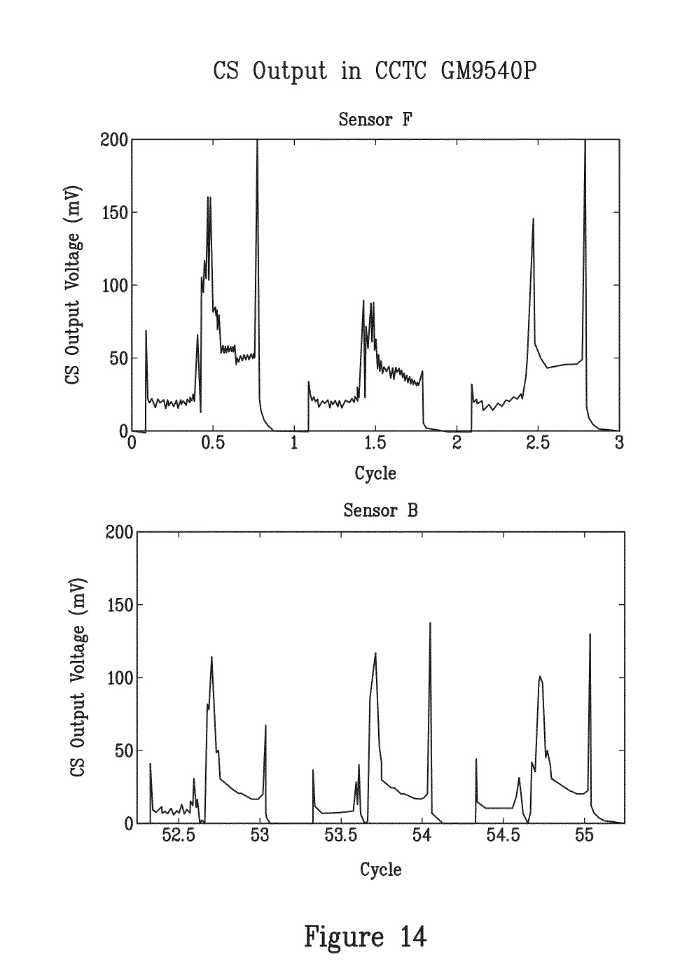

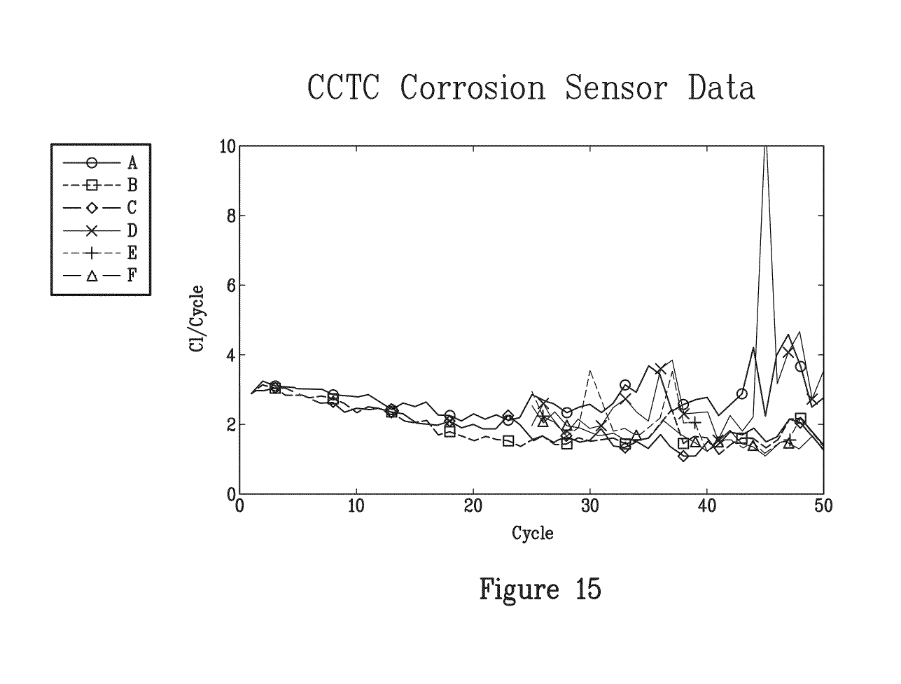

FIGS. 12-15 show CS output in CCTC using GM9540P Accelerated Corrosion Test.

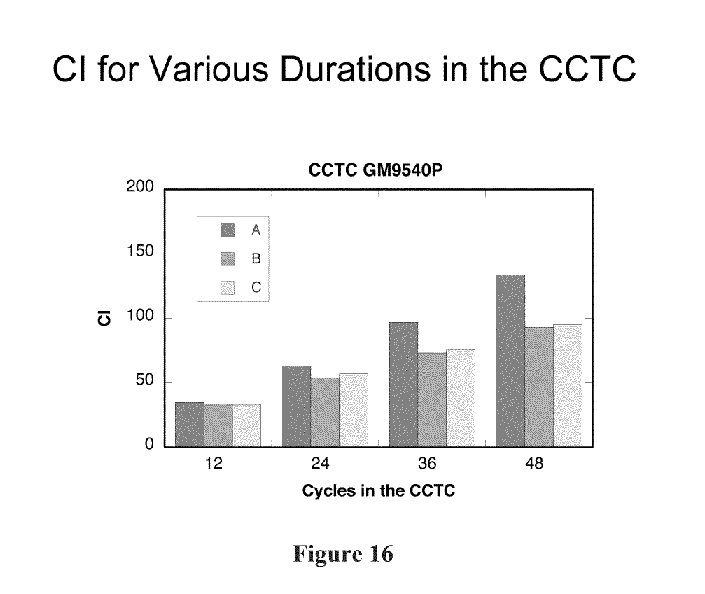

FIG. 16 shows CI for various 12-cycle periods in the CCTC. Positions of CSs in the CCTC may influence readings. Sensors A and D are in column 1, B and E are in column 2 and C and F are in column 3 Results are presented in Table 1.

TABLE 1
CI in various 12-cycle periods in the CCTC.

| | Sensor | | | | | | | |
|---|---|---|---|---|---|---|---|---|
| Cycles | A | B | C | D | E | F | AVG | SD |
| 1-12 | 35 | 33 | 33 | | | | 34 | 2 |
| 13-24 | 28 | 21 | 25 | | | | 25 | 3 |
| 25-36 | 34 | 19 | 18 | 28 | 23 | 27 | 25 | 6 |
| 37-48 | 37 | 20 | 19 | 41 | 21 | 18 | 26 | 10 |

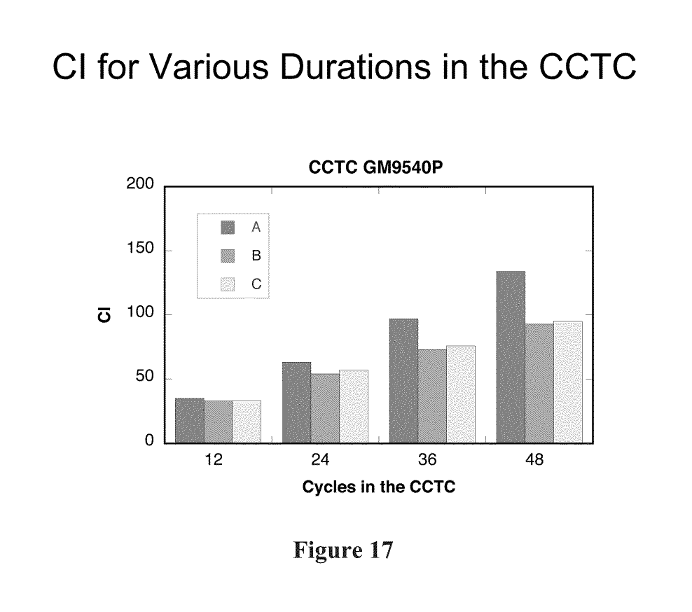

FIG. 17 presents a plot of CI versus cycles in the CCTC using GM9540P.

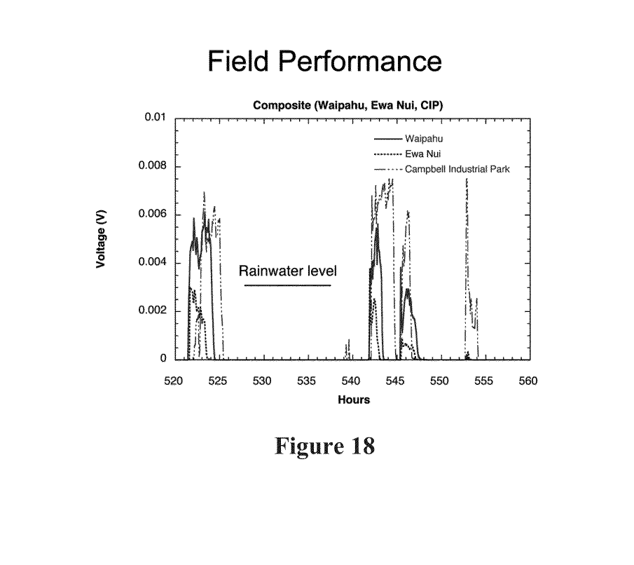

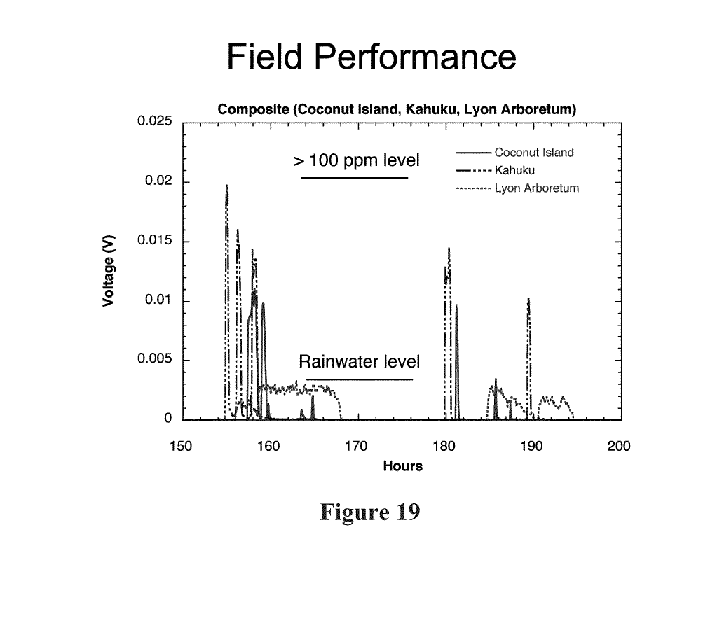

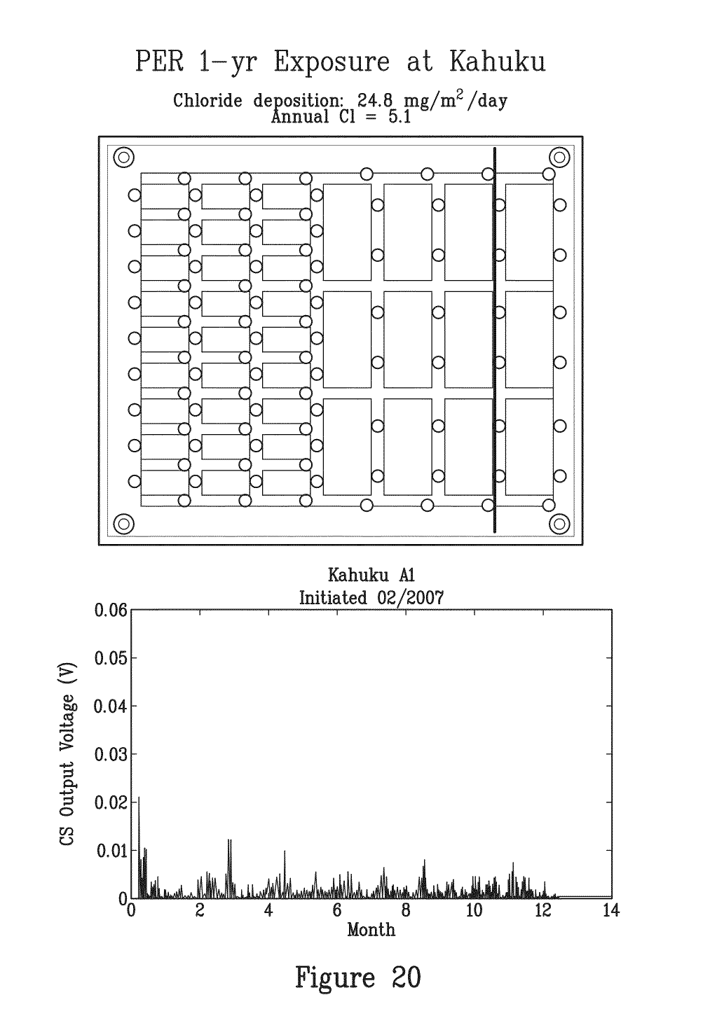

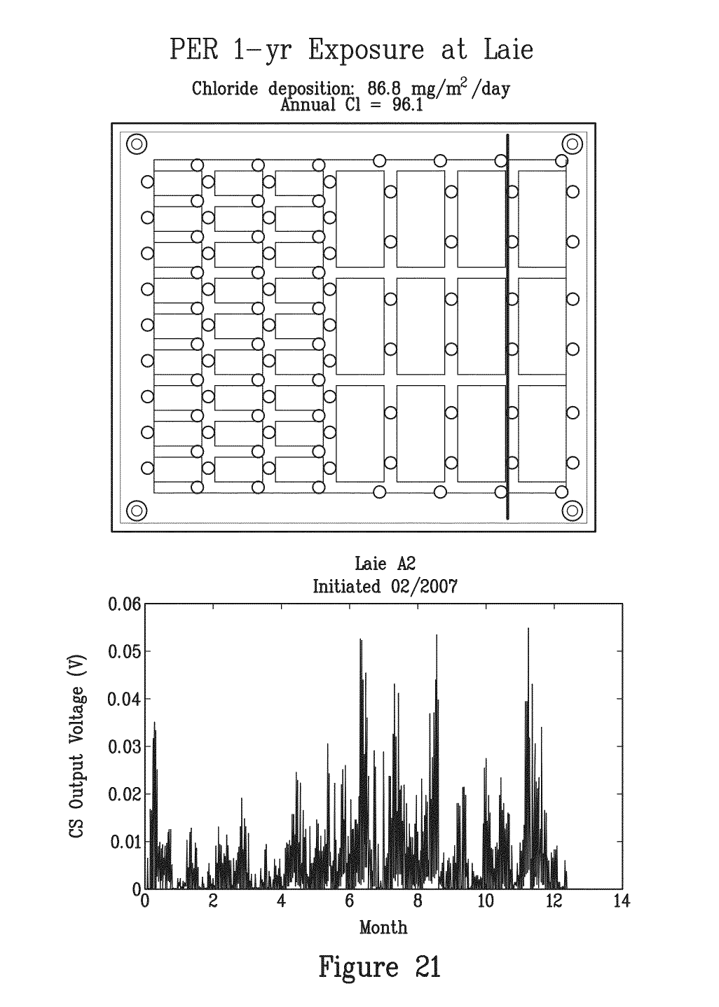

Field tests were also performed using the CSs. FIG. 18 shows voltage results over time for composite tests (Waipahu, Ewa Nui, and Campbell Industrial Park, each in Hawaii). Additional composite field performance results (Coconut Island, Kahuku, and Lyon Arboretum, each in Hawaii) are presented in FIG. 19. FIGS. 20 and 21 present 1 year exposure data at Kahuku and Laie (each in Hawaii).

What is claimed:

1. A corrosion sensor comprising:
a resistor,
a voltage meter or voltage data logger for determining voltage output across said resistor; and
at least three different layers, each layer comprising a different material, said layers comprising:
(a) corrosion-resistant conducting layer;
(b) metal layer; and
(c) electrically insulating layer deposed between said conducting layer and said metal layer;
wherein said resistor connects said conducting layer and said metal layer.

2. The corrosion sensor of claim 1, wherein said conductive layer comprises at least one of graphite, titanium, gold and platinum.

3. The corrosion sensor of claim 1, wherein said conductive layer comprises carbon/polymer or graphite/polymer fiber composite.

4. The corrosion sensor of claim 1, wherein said insulating layer comprises an insulating polymer or ceramic.

5. The corrosion sensor of claim 1, wherein said insulating layer comprises E-glass/polymer composite.

6. The corrosion sensor of claim 1, wherein said metal layer comprises a passive metal.

7. The corrosion sensor of claim 6, wherein said passive metal comprises aluminum.

8. The corrosion sensor of claim 1, additionally comprising a voltage data logger for recording the voltage or current across said resistor.

9. The corrosion sensor of claim 8, wherein said sensor does not have a power source other than that for said data logger.

10. A method for monitoring corrosivity of an environment in real time comprising:
placing a corrosion sensor of claim 1 into said environment;
monitoring the voltage across said resistor; and
correlating said voltage with corrosivity.

11. The method of claim 10, wherein correlating said voltage with corrosivity is made utilizing a set of calibration data, the set of calibration data relating voltage to corrosivity.

12. The method of claim 10, wherein said monitoring is accomplished by monitoring galvanic action between said conducting layer and said metal layer.

13. The method of claim 10, wherein said conductive layer comprises at least one of graphite, titanium, gold and platinum.

14. The method of claim 10, wherein said conductive layer comprises carbon/epoxy or graphite/epoxy fiber composite.

15. The method of claim 10, wherein said insulating layer comprises an insulating polymer or ceramic.

16. The method of claim 10, wherein said insulating layer comprises E-glass/epoxy composite.

17. The method of claim 10, wherein said metal layer comprises a passive metal.

18. The method of claim 17, wherein said passive metal comprises aluminum.

19. A method of recording the corrosivity history of an environment, said method comprising:
placing a corrosion sensor of claim 1 into said environment;
monitoring the voltage across said resistor; and
correlating said voltage with corrosivity.

20. The method of claim 19, wherein said conductive layer comprises at least one of graphite, titanium, gold and platinum; said insulating layer comprises an insulating polymer, ceramic or composite; and said metal layer comprises aluminum.
